(19) United States
(12) Patent Application Publication
(10) Pub. No.: US 2007/0094034 A1
(43) Pub. Date: Apr. 26, 2007

(54) Incident report transcription system and methodologies

(76) Inventors: Bradley M. Berlin, Santa Cruz, CA (US); Margaret O. Nyswonger, Santa Cruz, CA (US)

Correspondence Address: PILLSBURY WINTHROP SHAW PITTMAN, LLP, P.O. BOX 10500, MCLEAN, VA, 22102, US

(21) Appl. No.: 11/584,541

(22) Filed: Oct. 23, 2006

Related U.S. Application Data
(60) Provisional application No. 60/728,770, filed on Oct. 21, 2005.

(51) Int. Cl. G10L 11/00

(52) U.S. Cl. 704/273

(57) ABSTRACT

A system and methodologies are provided that support speech-based generation of incident reports.

### CROSS REFERENCE TO RELATED APPLICATIONS

This application claims priority to provisional application Ser. No. 60/728,770, filed Oct. 21, 2005, the contents of which is incorporated herein in its entirety by reference.

### BACKGROUND OF THE INVENTION

1. Field of the Invention

Invention embodiments relate to a system and methodologies that support speech-based generation of incident reports.

2. Description of Related Art

The amount of time law enforcement personnel spend developing written incident reports for their case-related activities can substantially impact the time personnel are able to directly support community policing activities, and ultimately impacts the average response time to emergency and other call-out situations.

### SUMMARY OF THE INVENTION

In accordance with at least one embodiment of the invention, a system and methodologies are provided that support speech-based generation of incident reports.

In accordance with at least one embodiment of the invention, a system and methodologies are provided that support a public safety focused police incident reporting, speech-to-text transcription interface.

In accordance with at least one embodiment of the invention, an automated continuous speech recognition platform is provided that meets the operational needs of the law enforcement personnel, improves the efficiency and effectiveness of report preparation, offers sufficient accuracy and user acceptance, is scalable to meet the capacity and cost requirements of both large and small jurisdictions, and can be integrated with commercial or open source records management systems.

### BRIEF DESCRIPTION OF THE DRAWINGS

FIG. 1 illustrates one implementation of an incident report transcription system designed in accordance with at least one embodiment of the invention.

### DETAILED DESCRIPTION OF EMBODIMENTS OF THE INVENTION

Conventionally, law enforcement personnel, e.g., police officers and detectives, utilize desktop software to enter data for incident reports into a data repository that stores such data, i.e., a Report Management System (RMS). For example, one such desktop software application is Microsoft MS Access™, which is a runtime application that may be used on a desktop system for entering report data and interacting with a conventional Records Management System (RMS). However, such desktop software requires “keying” in data on a keyboard, which requires a user's directed attention to both a keyboard and a display screen to effectively enter accurate data. Moreover, access to such display screens and keyboards routinely requires a user to work in an office environment at a desktop terminal rather than remaining in a field position where community policing activities may be maintained. As a result, a significant portion of a patrol officer's or detective's day can be consumed by completing and filing Incident Reports, case notes, and other narrative documents covering daily patrol and investigative activities. Depending on the operating environment in a specific jurisdiction, officers may key reports manually at a desk/workstation, or may dictate reports that are later converted to text documents in the appropriate format by a transcriptionist working from recordings.

The typical officer is not necessarily a skilled typist and may not be entirely comfortable in a dictation environment. In either event, the time required to complete these reporting requirements is time the officer is generally unavailable for community policing activities. The fact that officers may be off the street or out of their vehicles and in a precinct office completing these required reports impacts the response time to emergency situations in the community.

As a result, the time that law enforcement personnel spend completing incident and investigative reports is time that these law enforcement personnel are unavailable for the primary task of community policing. The fact that law enforcement personnel may be off the street or out of their vehicles and in a precinct office completing required reports impacts the response time to emergency situations in the community. Even with some degree of report automation, the formal reporting activity takes a considerable period of each personnel member's day—estimated from one to four hours per shift depending on the level of activity and complexity of specific incidents. However, voice transcription of reports can approach a rate of one hundred sixty words per minute compared to typically low typing rates of 30-40 words per minute or less. For a large police force of two thousand field law enforcement personnel, this improvement could result in the manpower equivalent of an additional 100+ Full Time Equivalents (FTEs) available for community policing, and a concomitant reduction in emergency situation response time.

Accordingly, implemented embodiments of the invention provide utility in that they generate immediate benefits beyond the positive impact on community policing activity, including rapid return on investment, ease of use, reduced turnaround times for reports, and automated or semi-automated conversion of codes and role-specific language to plain text.

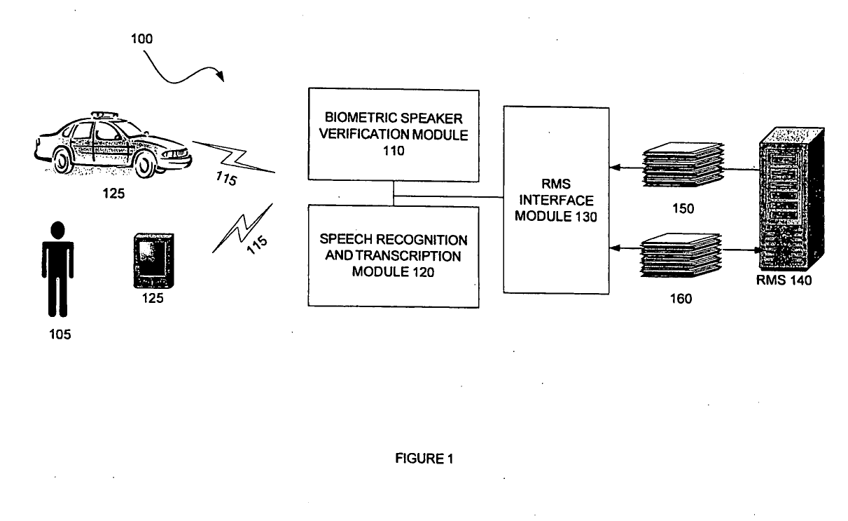

As illustrated in FIG. 1, an incident report transcription system designed in accordance with at least one embodiment of the invention includes various functional modules that interact and cooperate in a manner to support speech-based generation of incident reports. The system 100 may include a biometric speaker verification module 110, a speech recognition and transcription module 120 and an RMS interface module 130. Each of the biometric speaker verification module 110, speech recognition and transcription module 120 and RMS interface module 130 may be implemented in whole or in part in a server or server farm accessible via one or more communication links 115, which may or may not be part of a dedicated communication network (comprised by one or more public and/or private networks, e.g., wireless networks, intranets, the Internet, POTS network(s), radio, etc.). Alternatively, it should be understood that at least some portion, if not all of the hardware and/or software for implementing the biometric speaker verification module 110, speech recognition and transcription module 120 and RMS interface module 130 may be implemented at a personnel member's mobile unit 125.

Further, in accordance with at least one embodiment of the invention, the system may be implemented using “SWARM” technology for government internal operational use to increase efficiencies and effectiveness as well as for intelligence gathering and crime fighting operatives, to access, change, verify and track identity. SWARM technology may be defined as Swarm intelligence, for distributed algorithms and multiagent systems according to the social insect metaphor. See “Swarm Intelligence: From Natural Artificial Systems,” Eric Bonabeau, Marco Dorigo, Guy Theraulaz, January 2004. Oxford Publications and Santa Fe Institute, the entirety of which hereby being incorporated by reference.

In accordance with at least one implementation, the personnel member's mobile unit 125 may be implemented in a personnel member's vehicle; alternatively, the personnel member's mobile unit 125 may be implemented as a personal computer, smart phone/radio or other personal computing device that enables data entry via at least speech. Such an implementation may optionally include one or more text data entry and review interfaces, e.g., stylus and pressure screen interface, keyboard, etc.

The biometric speaker verification module 110 provides functionality to authenticate the identity of the personnel member 105 using the system 100. Thus, the biometric speaker verification module 110 may include various hardware and/or software depending on the means for verification to be used. Thus, the biometric speaker verification module 110 may be implemented as a layered security application that utilizes one or more commercially available technologies. In such an implementation, personnel may be identified from anywhere in the world thru the use of a voice verification system applications that can be accessed from a wired line telephone, wireless telephone, radio or a multimedia device.

There are various commercially available technologies for identifying who an individual is through various biometric technologies from fingerprint analysis to retina and iris scan, each method has an associated cost of use, level of security it provides, performance issues and user acceptance. Thus, selection of which biometric technologies are utilized should be based at least on the necessary level of security required to confirm personnel identity and performance issues associated with user and environment(s) in which the system is used.

For example, analysis of fingerprint patterns provides a medium level of security but technology for performing such analysis is subject to wear and soil. Similarly, analysis of personnel palm print patterns provides a medium level of security but hand injury and jewelry, e.g., rings, can cause problems in identification of personnel. Analysis of hand geometry dimensions of hands and fingers can provide a higher level of security; however, this biometric identification technique is also susceptible to error due to hand injury and jewelry.

Retina blood vessel patterns and iris patterns can be analyzed and provide a high level of security. However, the cost of implementing these biometric technologies is also high. Moreover, glasses and various environmental issues, e.g., lighting considerations, make implementation in the field somewhat complicated. Facial features may be analyzed to provide a medium level of security; however, the presence of glasses changes in hair style/color can effect recognition and identity verification. The rhythm, flow or other distinguishing features with which a personnel member writes their signature can be analyzed to verify identity. However, such mechanisms provide a relatively low level of security.

Also, voice pitch, tone, etc. may be analyzed to verify identity; however, such technologies are susceptible to line/background noise, etc. In such an implementation, the biometric speaker verification module may include any of a number of commercially available verification engines, e.g., SpeechSecure provided by SpeechWorks, Inc., 695 Atlantic Ave., Boston Mass. 02111

Optionally, depending on the level of security required and the cost implementation that is desired, the biometric speaker verification module 110 may merely verify an identity of a personnel member 115 based on entry of a security password in combination with a personnel member number, e.g., a badge number or employee number. Moreover, the biometric speaker verification module 110 may incorporate or cooperate with PKI Smart Card technology to provide an additional level of security.

Depending upon the environment in which the transcription system is used, one or more of these biometric identity verification technologies may be implemented with varying degrees of effectiveness. While voice pattern verification may provide a medium to high level of security, there may still be several problems present that make it non-useable in the use of large user communities. For example, a search method used to validate the personnel member's identity can take longer than a common human will wait. Accordingly, in at least one implementation of the invention, voice pattern verification may be utilized in combination with another security mechanism, e.g., password entry, to reduce the time needed to confirm an individual's identity.

Although conventional, continuous-speech-to-text recognition systems have been deployed in the public safety environment with mixed results, recent advances in the state of the art, have provided increased utility for utilizing speech recognition, specifically context driven recognition, wherein the speech recognition system is capable of discerning “meaning” (in a restricted sense) of the spoken text have been shown to significantly impact many areas of performance, including recognition accuracy, ease of use and user acceptance rates, ability to take normal speaking mannerisms into account (e.g., pauses, utterances such as “uh”, “ah”, etc.), “continuous” recognizer training based on corrections made to documents on review, the ability to recognize codes and role-specific language and convert to clear text, the ability to “word spot” or “phrase spot” to automatically pick out key information for form/report fields, etc.

Thus, the transcription functionality of the speech recognition module may be provided via a combination of one or more commercially available voice recognition technologies. The speech recognition and transcription module 120 may be implemented utilizing one or more of the following technologies including Scansof™, Speechworks™, MS Voice Server™, and other commercially available voice recognition technology.

The speech recognition and transcription module 120 may further require customization of proven recognition platforms and workflow engines with new vocabularies, grammars, and speech constructs, and integration into the existing RMS.

In health care and legal applications, properly designed and customized transcription systems with job-specific vocabularies and application features are relatively successful commercially, and have proven effective by achieving transcription accuracy rates approaching 99% and high levels of user acceptance. Their success can be explained in large part by the underlying research in development of vocabulary, evaluation of grammar and speaking patterns and customization that has been done to leverage COTS applications into community-specific transcription platforms, driving improved accuracy, usability, and user acceptance rates. These health care and legal transcription systems have very large custom vocabularies of words and phrases based on job and task-specific language, a fundamental requirement for recognition accuracy.

Thus, the system's speech recognition module may be trained using both a sample of actual incident reports in electronic text form and speech samples provided from a pool of varied personnel. More specifically, a body of existing incident reports may be utilized to provide a basis for development of vocabularies, stylistic patterns, abbreviations, codes, etc. used by personnel in completing incident reports. For example, a sample of at least 100 reports may be sufficient to enable accurate identification of vocabularies, stylistic patterns, abbreviations, etc. In such reports, it is foreseeable that specifics such as names and other sensitive information may require redaction to maintain privacy and comply with various regulations and statutes. Identification of vocabularies, stylistic patterns, abbreviations, etc. may be performed using printed reports in the alternative or in addition to the electronic incident reports. The speech recognition module may also utilize one or more of various commercially available mechanisms for automatic recognition of and translation of codes and unique language to standardized clear text. Further, in accordance with at least one embodiment, the speech recognition module may be configured to perform continuous “learning” for improved accuracy.

The type and level of ambient noise is another critical issue in use of any transcription (or any speech-recognition) application. High ambient noise levels such as might be found in a busy precinct or patrol car can have a substantial negative impact on recognition accuracy if that ambient noise makes its way into the speech input path. Thus, microphone types that preserve sufficient speech clarity while reducing ambient noise to minimum levels are valuable.

The RMS interface module 130 may be configured to provide integration of the biometric speaker verification module 110 and the speech recognition and transcription module 120 with an RMS. Thus, the RMS interface module 130 enables the inventive system to provide a text-to-speech front end for a conventional RMS 140 and provide navigation and control command structures to enable personnel to utilize the inventive system to input information into and access information in the conventional RMS 140. It is foreseeable that some quantity of existing electronic format incident reports 150 may conventionally exist in the RMS 140 prior to implementation of the invention. Thus, in accordance with at least one embodiment of the invention, the RMS interface module 130 may also provide access to the conventionally generated electronic format incident reports 150. Additionally, the RMS interface module 130 provides the functionality to store and access newly generated electronic format incident reports 160 generated via the speech recognition and transcription module 120 in the RMS system 140.

In accordance with at least one embodiment of the invention, one or more RMS interfaces utilized in the RMS interface module 130 may be based on open standards.

In accordance with at least one embodiment of the invention, subsequent to initial report generation, the system may provide real-time or near real-time availability of created reports on the personnel member's workstation or mobile personal computer for review and correction. In accordance with at least one embodiment of the invention, the system may be configured to be adaptable to a wide range of speaking styles, speeds, accents, non-text utterances and high-noise environments.

In accordance with at least one embodiment of the invention, the system may be configured to capture officer field notes in real time using a tactical microphone enabling access by the officer within a distance range of, for example, 500 feet of the patrol car. As a result, such an implementation may contribute significantly to officer safety by freeing hands from the need for manual note taking. That implementation also could be used for real-time access to wants and warrant information without jeopardizing the officer's position or requiring use of their hands while on scene of incident.

In accordance with at least one embodiment of the invention, when law enforcement personnel utilize the system designed in accordance with the invention, an officer or detective may utilize a communication mechanism, e.g., wireless, phone connection or PC to access the report application. Subsequently, personnel can fill out report(s) by simply speaking the information to be included. The voice file and report may then be stored on long term storage. Subsequently, transcription service personnel (and/or a module configured to automatically or semi-automatically correct and/or audit the transcribed information) may receive the report(s) and voice files for correction and audit; in this way, the system may be self-training. Following these operations, the report may be moved to long term report storage.

While this invention has been described in conjunction with the specific embodiments outlined above, it is evident that many alternatives, modifications and variations will be apparent to those skilled in the art. Accordingly, the various embodiments of the invention, as set forth above, are intended to be illustrative, not limiting. Various changes may be made without departing from the spirit and scope of the invention.

For example, it should be understood that the system may be implemented with one or more of various commercially available encryption technologies as deemed necessary to ensure a requisite level of confidentiality and data integrity. In accordance with at least one embodiment of the invention, the system may be integrated with the CAPSIT OpenRMS system. Further, the system may be configured to be capable of standards-based integration (e.g., XML or Microsoft HID specification) with other RMS platforms.

In accordance with at least one embodiment of the invention, the mobile unit may include or work in combination with a Keep Alive Sensor(KAS) that may be configured to ensure that the law enforcement personnel has access to at least one communication mechanism, e.g., radio, wireless, etc., and enables switching to another communication mechanism, e.g., radio wireless, etc. when a presently used communication mechanism is no longer available.

It should be understood that the system architecture may be scalable to serve the needs of large or small jurisdictions cost effectively, and accessible on either a local (e.g., precinct) or remote (patrol car mobile unit) basis to fit the operational strategies of different jurisdictions.

In accordance with at least one embodiment of the invention, the system may be implemented in connection with a broadband wireless system to provide full high speed web and data access to mobile unit in patrol cars.

In accordance with at least one embodiment of the invention, the system is integrated with a single voice interface point for transcription as well as license plate and wants/warrants information with a speaker directed control application such as is available with Advanced Public Safety (APS).

Further, although embodiments of the invention have been described in connection with transcription functionality for law enforcement personnel in association with report drafting, it should be understood that invention embodiments may also be utilized by fire safety personnel, dispatch, internal operations, contingency planning or other appropriate personnel.

What is claimed is:

1. An incident report transcription system comprising:
a biometric speaker verification module configured to verify an identity of a speaker via one or more biometric indicia;
a speech recognition and transcription module configured to accept spoken data entry commands and transcribe spoken data to generate at least one electronic format incident report; and
a records management system interface module configured to store the at least one electronic format incident report in a records management system following generation.

2. The system of claim 1, wherein the biometric speaker verification module and speech recognition and records management system interface module are included in a mobile unit assigned to one or more personnel members.

3. The system of claim 2, wherein the mobile unit is implemented in a personnel member's vehicle.

4. The system of claim 2, wherein the mobile unit is implemented as a personal computer.

5. The system of claim 2, wherein the mobile unit is implemented as a personal computing device that enables data entry via at least speech.

6. The system of claim 2, wherein the mobile unit includes at least one text data entry and review interface.

7. The system of claim 1, wherein the mobile unit includes a Keep Alive Sensor configured to monitor and maintain at least one communication mechanism for use by the mobile unit.

8. The system of claim 1, wherein the biometric speaker verification module, speech recognition and transcription module and records management system interface module are implemented in at least one server.

9. The system of claim 1, wherein the system is implemented using distributed algorithms and multiagent systems.

10. The system of claim 1, wherein the biometric speaker verification module is configured to authenticate the identity of the personnel member using the system.

11. The system of claim 1, wherein the speech recognition and transcription module is trained using both a sample of actual incident reports in electronic text form and speech samples provided from a pool of varied personnel.

12. A method for generating at least one transcribed, electronic format incident report, the method comprising:
verifying an identify of a speaker via a biometric speaker verification module that analyzes one or more biometric indicia;
implementing spoken data entry commands from the speaker and transcribing data spoken by the speaker to generate at least one electronic format incident report; and
storing the at least one electronic format incident report in a records management system.

13. The method of claim 12, wherein the verification, implementation and storing are performed by a mobile unit associated with at least one personnel member.

14. The method of claim 13, wherein the mobile unit is implemented in a personnel member's vehicle.

15. The method of claim 13, wherein the mobile unit is implemented as a personal computer.

16. The method of claim 13, wherein the mobile unit is implemented as a personal computing device that enables data entry via at least speech.

17. The method of claim 13, wherein the mobile unit includes at least one text data entry and review interface.

18. The method of claim 13, wherein the mobile unit includes a Keep Alive Sensor configured to monitor and maintain at least one communication mechanism for use by the mobile unit.

19. The method of claim 12, wherein the system is implemented using distributed algorithms and multiagent systems.

20. The method of claim 12, wherein the biometric speaker verification module is configured to authenticate the identity of the personnel member using the system.

21. The method of claim 12, further comprising training using both a sample of actual incident reports in electronic text form and speech samples provided from a pool of varied personnel.
